(19) United States
(12) Patent Application Publication
(10) Pub. No.: US 2005/0069756 A1
(43) Pub. Date: Mar. 31, 2005

(54) High temperature fuel cell

(75) Inventors: Gilles Robert, Zurich (CH); Andreas Franz-Josef Kaiser, Elgg (CH); Emad Batawi, Winterthur (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Hexis AG, Winterthur (CH)

(21) Appl. No.: 10/934,094

(22) Filed: Sep. 3, 2004

(30) Foreign Application Priority Data
Sep. 5, 2003 (EP) 03405649.9

(51) Int. Cl. H01M 4/86; B05D 5/12; H01M 8/12

(52) U.S. Cl. 429/45; 427/115; 429/30

(57) ABSTRACT

The high temperature fuel cell includes a fuel side carrier structure (1), which includes an anode layer (1a) and which serves as a carrier for a thin, gas-tight sintered solid material electrolyte layer (2). This carrier is formed by a heterogeneous phase (1b) in which hollow cavities in the form of macro-pores and also micro-pores are contained. The heterogeneous phase includes two part phases which penetrate each other in interlaced manner. The first part phase consists of a ceramic material and the second part phase has metal, for which a redox cycle can be carried out with a complete reduction and renewed oxidation. The first part phase is composed of large and small ceramic particles (10, 11), from which inherently stable “burr corpuscles” (12, 13) are formed as islands in the heterogeneous phase. The second part phase produces an electrically conductive connection through the carrier structure in the presence of the reduced form of the metal. The large and small ceramic particles have an average diameter d₅₀ larger than 5 μm and smaller than 1 μm respectively. The volume ratios of the ceramic particles are selected in such a manner that the “burr corpuscles” are associated with an “adhesive burr composite” through which the carrier structure is stabilised against changes in stability. By means of this stabilisation the metric characteristics are substantially maintained at the boundary surface to the electrolyte layer so that volume changes of the second part phase during the redox cycle leave the gas tightness of the electrolyte layer substantially intact. For high temperature fuel cells, in which the electrolyte layer is formed as a carrier and the anode layer is applied to this carrier, the heterogeneous phase defined above can likewise be used to advantage.

The invention relates to a high temperature fuel cell with a carrier structure including an anode layer at the fuel-side accordance with the precharacterising part of claim 1 and also to a high temperature fuel cell with an electrolyte layer formed as a carrier, on which the anode layer is applied. The invention also relates to a method for the manufacture of fuel cells of this kind.

An SOFC fuel cell with a fuel-side carrier structure is known from the not prior published EP-A-1 343 215 (=P.7183) which forms an anode substrate and which serves as a carrier for a thin film electrolyte and also a cathode. In the contact region between the anode, which is a thin part layer of the carrier structure, and the electrolyte, electrochemical reactions take place, at so-called three phase points (nickel/solid electrolyte/gas), in which the nickel atoms are oxidised by oxygen ions (O²⁻) of the electrolytes and these are then reduced again by a gaseous fuel (H₂,CO), with H₂O and CO₂ being formed and electrons freed during oxidation being conducted further by the anode substrate. The EP-A-1 343 215 describes a carrier structure which has a “redox stability” and which with reference to this redox stability is sufficiently well designed with regard to gas permeability and also economics for a use in high temperature fuel cells.

The carrier structure of these known fuel cells is made up of an electrode material and contains macro-pores, which are produced by means of pore formers and form the communicating cavities. The electrode material includes skeleton-like or net-like continuous structure of particles joined by sintering, so-called “reticular systems” (can also be termed percolating phases) which form two interlaced systems: a first reticular system made of ceramic material and a second reticular system which contains metals or one metal—Ni in particular—and which produces an electrically conductive connection through the carrier structure. The electrode material has the characteristics that during the carrying out of redox cycles by means of the change between oxidising and reducing conditions firstly no substantial changes of characteristic occur in the ceramic reticular system and secondly an oxidation or rather reduction of the metal results in the other reticular system. Moreover, the two reticular systems together form a dense structure which contains micro-pores in the oxidised condition, the proportion of which in relation to the volume of the electrode material is, or can be, smaller than 5% related to the volume of the electrode material.

The two reticular systems arise in a natural way from the constituent particles in the form of a statistical distribution of the particles, if these are prepared in such a way that the two kinds of particles respectively exhibit a narrow size spectrum, when the proportion for each reticular system amounts to 30% per unit volume and when the particles are mixed with each other homogeneously. The system of communicating cavities formed by the macro-pores is likewise a reticular system. This hollow cavity system results in the necessary gas permeability.

The carrier structure described may show the desired redox stability, however in other respects it shows deficiencies. During a redox cycle the structure contracts during the transition from the oxidised state to the reduced state (constriction); the electrolyte layer is correspondingly placed under a compressive pressure. The compression is followed by an expansion during the reversed redox transition. This expansion is greater than the compression by more than 0.01% due to irreversible processes in the carrier structure in many of the anode substrates. Cracks develop in the electrolyte layer, which represents a gas separating membrane, due to the expansion through which the necessary gas tightness is lost.

The object of the invention is to produce a high temperature fuel cell with a fuel side carrier structure including an anode layer in which the electrolyte layer applied to the carrier structure remains gastight during a redox cycle. This object is satisfied by the fuel cell defined in claim 1.

The high temperature fuel cell includes a fuel side carrier structure which includes an anode layer and which serves as a carrier for a thin, gastight sintered solid material electrolyte layer. This carrier structure is formed by a heterogeneous phase in which hollow cavities in the form of macro-pres and micro-pores are contained. The heterogeneous phase includes two part phases which penetrate one another in interlaced manner. The first part phase is composed of a ceramic material and the second part phase has metal for which a redox cycle can be carried out with a complete reduction and renewed oxidation. The first part phase is composed of large and small ceramic particles, from which inherently stable “burr corpuscles” are formed as islands in the heterogeneous phase. The second part phase produces an electrically conductive connection through the carrier structure in the presence of the reduced form of the metal. The large and small ceramic particles have an average diameter d₅₀ larger than 5 μm and smaller than 1 μm respectively. The quantity ratios of the ceramic particles are selected in such a manner that the “burr corpuscles” are associated with an “adhesive burr composite”, through which the carrier structure is stabilised against changes in stability. The metric characteristics of the carrier structure are substantially maintained at the boundary surface to the electrolyte layer so that volume changes of the second part phase during the redox cycle leave the gas-tightness of the electrolyte layer substantially intact.

The dependent claim 2 refers to advantageous embodiments of the fuel cell of the invention in accordance with claim 1.

For high temperature fuel cells, in which the electrolyte layer is formed as a carrier and in which the anode layer is applied to this layer, the heterogeneous phase, defined in claim 1, can likewise advantageously be used in accordance with claim 3. The special structure of this heterogeneous phase is an effective means against shear forces which are too large, which occur due to the volume difference between the reduced condition and the oxidised condition of the anode material at the boundary surface between the anode layer and the electrolyte layer and which can cause a de-lamination.

The dependent claims 4 to 7 refer to advantageous embodiments of the fuel cells in accordance with the invention. Methods for the manufacture of the fuel cells are the subject of the claims 8 and 9.

The invention will be explained with reference to the drawings, which show:

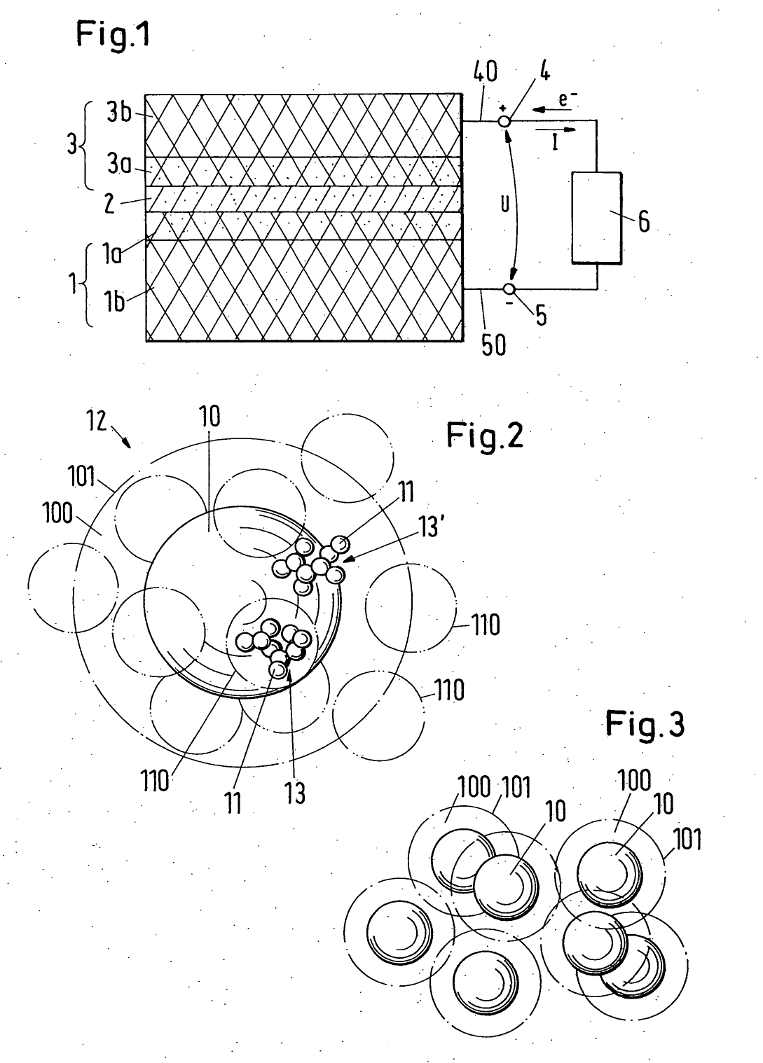

FIG. 1 a schematic illustration of a fuel cell in accordance with the invention

FIG. 2 an illustration of a structure designated as a “burr corpuscle”,

FIG. 3 an illustration of the term “adhesive burr composite” and

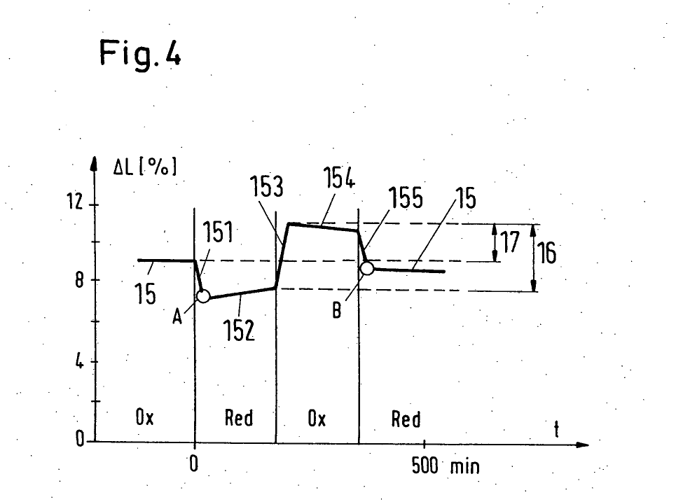

FIG. 4 a diagram showing the constriction and expansion of a sample during a redox cycle.

In high temperature fuel cell as schematically illustrated in FIG. 1, electrode reactions are carried out to produce an electrical current 1, namely reducing reactions in an anode layer 1a, which is part of a carrier structure 1; and oxidising reactions on a cathode 3 which is composed of an electrochemically active electrode layer 3a and a second part layer 3b. A larger part 1b of the carrier structure 1 is formed by porous, gas permeable reticular systems. Water and carbon dioxide arise in the anode layer 1a from hydrogen and carbon monoxide which form the gaseous fuel. At the cathode 3 molecular oxygen of a second gas flow (air for example) reacts to ionic oxygen O²⁻—while taking up electrons e⁻ from a metallic conductor 40 which produces a connection to a pole 4. The oxygen ions move through a solid material electrolyte 2 which forms a thin, gas-tight sintered electrolyte layer. This separates the two electrode layers 1a and 3a in gas-tight manner; it is conductive for the oxygen ions at temperatures over 700° C. The reducing anode reaction takes place with the oxygen ions with the donation of electrons to a further metallic conductor 50 which produces a connection to a pole 5.

A consumer 6 which loads the fuel cell with an electrical resistance is arranged between the poles 4 and 5. In the practical use of the fuel cell the voltage U between the poles 4 and 5 is produced by a stack of cells connected in series.

On the fuel side the high temperature fuel cell in accordance with the invention contains the carrier structure 1 which includes the anode layer 1a and a second part layer, formed by a heterogeneous phase 1b. By the phase 1b hollow cavities are formed in the form of macro-pores and also micro-pores. The macro-pores bring about the gas permeability of the carrier structure 1. The heterogeneous phase 1b contains two part phases which penetrate one another in interlaced manner. The first part phase comprises a ceramic material and the second part phase has metal for which a redox cycle can be carried out with a complete reduction and renewed oxidation. The second part phase comprises an electrically conductive connection through the carrier structure 1 in the presence of the reduced form of the metal.

The first part phase is composed of large and small ceramic particles 10 and 11 from which inherently stable “burr corpuscles” 12 and 13 are formed as islands in the heterogeneous phase 1b: see FIG. 2. The large ceramic particles 10 have an average diameter d₅₀ larger than 5 or 10 μm; this diameter is preferably approximately 20 μm. The average diameter d₅₀ is less than 1 μm for the small ceramic particles.

The second part phase forms an approximately homogeneous matrix together with the small ceramic particles 11 of the first part phase. The large ceramic particles 10 are uniformly embedded in this matrix. The particle density of the small ceramic particles 11 is selected in such a manner that clusters each including a plurality of particles 11 occur. On sintering of the carrier structure the particles 11 form into inherently stable structures 13 or 13′ in the clusters. Moreover, on sintering, one of these structures, the structure 13′ with the large ceramic particles 10, join into “large burr corpuscles” 12. A large burr corpuscle 12 of this kind is composed of a core which consists of a large ceramic particle 10 and a halo 100 in which the joined-on structures 13′ are located. The average extension of the halo 100 is given by the sphere 101 drawn in chain-dotted lines in FIG. 2. The larger the particle density of the small ceramic particles 11 is selected to be, the larger the diameter of the sphere 101. This diameter also depends on the size of the small ceramic particles 11. In other words it depends on the particle density of the small ceramic particles 11 and also on the diameters of the large and small ceramic particles 10 and 11.

Apart from the burr corpuscle 12, small spheres 110 are also drawn in chain-dotted lines in FIG. 2. These spheres are associated with the structures 13 which are not connected to the large ceramic particles 10. The diameters of the spheres 110 likewise grow with increasing particle density of the small ceramic particles 11. If this particle density exceeds a critical size, the small ceramic particles 11 join together to a percolating phase in which the spheres 110 have united to a single composite action. The particle density of the small ceramic particles 11 and also their size are selected so that the spheres 110 have markedly smaller diameters than the spheres 101. The associated structures 13 which are located inside the above-named matrix will be termed “small burr corpuscles” 13 in the following.

The quantity ratios of the ceramic particles are selected in such a way that the burr corpuscles 12, 13 associate themselves to an “adhesive burr composite”, through which the carrier structure 1 is stabilised against changes in stability: see FIG. 3. Changes in stability can result during reduction of the second part phase (second reticular system). In this process which is associated with a constriction, the particles which are initially composed of metal oxide are movable. They rearrange themselves wherein the macroscopic shape of the carrier structure 1 can change. A change in shape of this kind is severely limited by the stabilisation. This results from the structures 13′ becoming hooked up in the halos 100 when the large burr corpuscles 12 are arrange so close together that halos 100 of neighbouring burr corpuscles 12 overlap. The small burr corpuscles 13 likewise contribute by hooked engagement to the adhesion between the large burr corpuscles 12. In the reduction of the second part phase the carrier structure can only contract in a very limited manner thanks to the adhesive burr composite. The burr corpuscles 12 and 13 which are associated due to hooked engagements form a composite, the adhesive burr composite which is very flexible with regard to small elongations and only allows small stresses to arise. The electrolyte layer which is relatively rigid is thus only loaded with weak tensile forces by the carrier structure 1 in which the second part phase only displays a fluid-like behaviour during the constriction process.

The carrier structure is also correspondingly stabilised by the adhesive burr composite during oxidation. By means of this stabilisation the metric characteristics of the carrier structure 1 at the boundary surface to the electrolyte layer 2 are largely maintained. Volume changes of the second part phase during the redox cycle thus leave the gas tightness of the electrolyte layer substantially intact so that the efficiency of the fuel cells is maintained; or the gas tightness is only impaired to the extent that a tolerable loss of efficiency results.

Shear forces also arise between the anode layer and the electrolyte layer, when the oxidation condition of the anode material changes. Due to the adhesive burr composite these shear forces are relatively weak. When the anode layer is applied to an electrolyte layer used as a carrier, shear forces of this kind do not, as a rule, suffice to cause a de-lamination of the anode layer.

FIG. 4 shows how the linear extension L of a sample—graph section 15—changes during a redox cycle. The change in length ΔL is given on the abscissa which initially has the value which results through the heating up to the operating temperature of the fuel cell of 800° C. and at oxidating conditions (in the ordinate range “Ox”). At reducing conditions due to a hydrogen atmosphere a constriction results with a length reduction on the graph section 151 to the point A (in the ordinate range “Red”). The metal of the sample is reduced at this point A. Subsequently—graph section 152—the length in the reduced condition increases again slightly, probably due to relaxation processes in which elastic tensions are released. If the hydrogen is replaced with air, then the linear extension L increases again (graph section 153) and moreover more than the length had decreased during the reduction. In the oxidised condition a small alteration in length takes place, possibly also due to relaxation phenomena: graph section 154. During renewed reduction the linear extension L becomes shorter again: graph section 155, point B. At point B the redox cycle begun at point A is complete. The two points A and B should lie at the same height if only reversible processes occur during the redox cycle. As can be seen from FIG. 5, an irreversible extension is present.

The extensions which have arisen due to the oxidation are illustrated in FIG. 4 with the double arrows 16 and 17. The double arrow 17 refers to the irreversible elongation which is associated with a redox cycle. The irreversible extension 17 should be as small as possible for a suitable anode substrate. This requirement is an expedient criterion in the search for suitable compositions. A search using these selection criteria has been carried out with a plurality of samples.

The anode substrate which comprises the heterogeneous phase 1b contains zirconium oxide YSZ stabilised with Y in the first part phase and Ni as a metal in the second part phase. The second part phase consists wholly or largely of NiO particles adhered joined together by sintering, when the metal is present in oxidised form. The matrix between the large ceramic particles 10 has a heterogeneous grain structure with regard to the NiO particles and the small ceramic particles 11. For samples which have been examined, the composition of which has proved to be advantageous, the particle size ratio of the heterogeneous grain structure is in the range between 2:1 and 5:1; in this arrangement the NiO particles have an average grain size d₅₀ in the range of 0.5 to 2 μm. The quantity ratio between the first and the second part phase lies—in per cent by weight—in the range from 50:50 to 25:75, preferably at approximately 40:60.

In a particularly advantageous sample the length of the double arrow 17 has practically disappeared in the diagram of FIG. 4. This sample is characterised by the following parameters: 60% by weight and d₅₀=0.74 μm for NiO, 40% by weight and d₅₀=0.2 and 20 μm respectively for YSZ using two parts coarse YSZ and one part fine YSZ.

Outside the anode layer 1a the micro-pores and macro-pores of the carrier structure are uniformly distributed. For the macro-pores the volume ratio amounts to 15-35, preferably more than 20% by volume; for the micropores it preferably amounts to less than 10% by volume. The average diameters of the macro-pores have values between 3 and 25 μm, while those of the micro-pores have values between 1 and 3 μm. The carrier structure 1 has a layer thickness of 0.3 to 2 mm, preferably 0.6 to 1 mm. The thickness of the electrolyte layer is smaller than 30 μm, preferably smaller than 15 μm.

In a method for the manufacture of the fuel cell in accordance with the invention the metal for the second phase is used in oxidised form in the production of a blank for the carrier structure. The material for the solid electrolytes is applied as a slurry to the said blank by means of a thin layer process for example. Subsequently the coated blank is sintered. One of the following part methods can be used for the production of the carrier structure for example: foil casting, roll pressing, wet pressing or isostatic pressing. The thin layer electrolyte can be applied by other methods: screen printing, spraying or casting of slurry, slurry casting in a vacuum (vacuum slip casting) or reactive metallization.

1. A high temperature fuel cell with a carrier structure (1) including an anode layer at the fuel side as a carrier structure for a thin, gas-tight sintered solid material electrolyte layer (2), said carrier structure including a heterogeneous phase (1b) and hollow cavities formed by this phase in the form of macro-pores and also micro-pores, wherein the heterogeneous phase contains two part phases which penetrate each other in interlaced manner, the first part phase consisting of a ceramic material and the second part phase having metal, for which a redox cycle can be carried out with a complete reduction and renewed oxidation, the first part phase being composed of large and small ceramic particles (10, 11) from which inherently stable “burr corpuscles” (12, 13) are formed as islands in the heterogeneous phase and the second part phase producing an electrically conductive connection through the carrier structure in the presence of the reduced form of the metal,
characterised in that the large and the small ceramic particles have an average diameter d50 larger than 5 μm and smaller than 1 μm respectively, the quantity ratios of the ceramic particles being selected in such a manner that the “burr corpuscles” are associated to form an “adhesive burr composite” through which the carrier structure is stabilised against changes in stability, while the metric characteristics of the carrier structure are substantially maintained at the boundary surface to the electrolyte layer by means of this stabilisation so that volume changes of the second part phase during the redox cycle leave the impermeability to gas of the electrolyte layer substantially intact.

2. A fuel cell in accordance with claim 1 characterised in that the carrier structure (1) has a layer thickness of 0.3 to 2 mm, preferably 0.6 to 1 mm, in that the thickness of the electrolyte layer (2) is smaller than 30 μm, preferably smaller than 15 μm and that the micro-pores and the macro-pores of the carrier structure are distributed uniformly outside the anode layer, with the proportion by volume of the macro-pores amounting to 15-35, preferably to more than 20% by volume, and for the micro-pores to preferably less than 10% by volume and with the average diameters of the macro-pores having values between 3 and 25 μm, while those of the micro-pores has values between 1 and 3 μm.

3. A high temperature fuel cell with a solid material electrolyte layer which is formed as a carrier for electrode layers and which separates an anode layer from a cathode layer in gas-tight manner, wherein the anode layer applied to the fuel side forms a heterogeneous phase with two part phases which penetrate one another in interlaced manner, the first part phase comprising a ceramic material and the second part phase having metal for which a redox cycle with a complete reduction and renewed oxidation can be carried out, the first part phase being composed of large and small ceramic particles (10, 11) from which inherently stable “burr corpuscles” (12, 13) are formed like islands in the heterogeneous phase and the second part phase producing an electrically conducting connection through the carrier structure in the presence of the reduced form of the metal,
characterised in that the large and the small ceramic particles have an average diameter d50 larger than 5 μm and smaller than 1 μm respectively, the quantity ratios of the ceramic particles being selected such that the “burr corpuscles” are associated to form an “adhesive burr composite” by which the carrier structure is stabilised against changes in shape, while by means of this stabilisation the metric characteristics of the anode layer are substantially maintained at the boundary surface to the electrolyte layer so that only weak shear forces occur which do not cause any de-lamination of the anode layer.

4. A fuel cell in accordance with claim 1 characterised in that, together with the small ceramic particles (11) of the first phase, the second part phase forms an approximately homogeneous matrix in which the large ceramic particles (10) are uniformly embedded and in connection with a part of the small ceramic particles (10), form large “burr corpuscles” (12) while small “burr corpuscles” (13) which are only composed of small ceramic particles are located inside the matrix.

5. A fuel cell in accordance with claim 4 characterised in that the first part phase consists of zirconium oxide YSZ stabilised with Y, of doped cerium oxide, of a perovskite or of another ceramic material and the second part phase contains Ni as a metal to which Cu is alloyed, for example.

6. A fuel cell in accordance with claim 5 characterised in that, when the oxidised form of the metal is present, the second part phase is wholly or substantially comprised of NiO particles which have been joined together by sintering.

7. A fuel cell in accordance with claim 5 characterised in that—in per cent by weight—the quantity ratio between the first and the second part phase lies in the range from 50:50 to 25:75, preferably at around 40:60.

8. A method for the manufacture of a fuel cell in accordance claim 1 characterised in that one of the following part methods is used for the production of the layer used as a carrier: casting as a slurry, foil casting, roll pressing, wet pressing or isostatic pressing.

9. A method for the manufacture of a fuel cell in accordance with claim 1, characterised in that in the production of a blank for the carrier structure (1) on which the solid material electrolyte layer (2) is applied as a slurry by means of a thin layer process, for example by means of screen printing, the metal of the second part phase is used in oxidised form and in that the blank is sintered together with the applied electrolyte material.
